(19) United States
(12) Patent Application Publication
(10) Pub. No.: US 2012/0205310 A1
(43) Pub. Date: Aug. 16, 2012

(54) METHOD AND DEVICE FOR RECYCLING OF WASTEWATER

(76) Inventor: Zicheng WU, Nanjing (CN)

(21) Appl. No.: 13/450,452

(22) Filed: Apr. 18, 2012

Related U.S. Application Data
(63) Continuation-in-part of application No. PCT/CN2011/076934, filed on Jul. 7, 2011.

(30) Foreign Application Priority Data
Jan. 28, 2011 (CN) 201110031043.2

(51) Int. Cl. C02F 9/12

(52) U.S. Cl. 210/638; 210/199; 210/139

(57) ABSTRACT

A method for treating wastewater including: flocculating and granulating the wastewater in a wastewater collection pool through a flocculation sedimentation tank; pumping the flocculated water with a high/low turbidity into a hair filter through a lift pump; pumping the pretreated water into an organic/inorganic membrane filter to yield clear water containing detergent; treating the clear water containing detergent with activated carbon and an ultraviolet lamp; raising the water pressure to 10-15 Kg using a high-pressure pump, and pumping the neutral clear water into a reverse osmosis apparatus for further removal of inorganic matters, organic matters, virus, and bacteria to obtain purified water. A device for recycling treatment of car-washing and laundry wastewater is also provided.

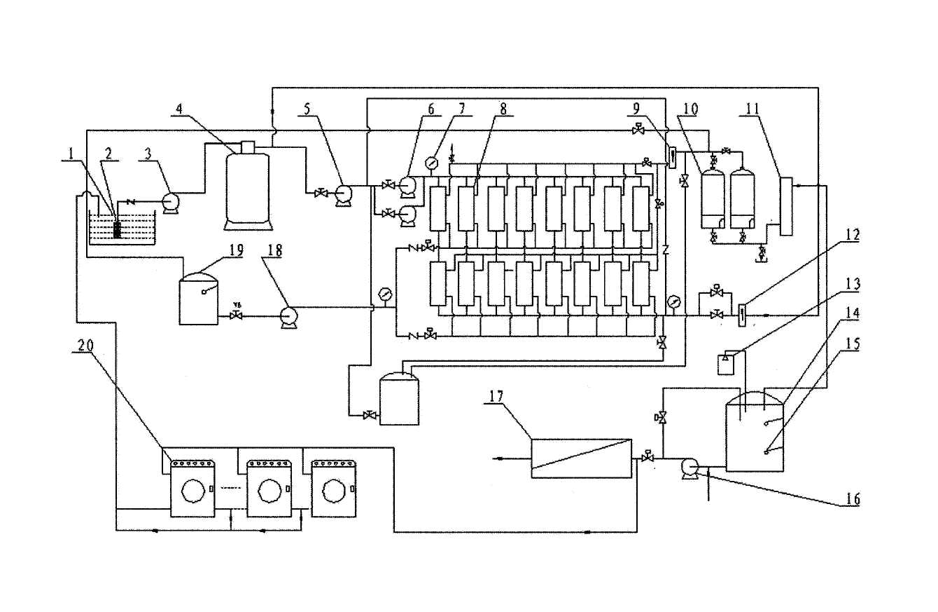

### CROSS-REFERENCE TO RELATED APPLICATIONS

This application is a continuation-in-part of International Patent Application No. PCT/CN2011/076934 with an international filing date of Jul. 7, 2011, designating the United States, now pending, and further claims priority benefits to Chinese Patent Application No. 201110031043.2 filed Jan. 28, 2011. The contents of all of the aforementioned applications, including any intervening amendments thereto, are incorporated herein by reference.

### BACKGROUND OF THE INVENTION

1. Field of the Invention

The invention relates to a method and a device for treating the high/low turbidity laundry or car-washing wastewater into clear tap water (the water quality can reach the standards of purified water) for recycling use.

2. Description of the Related Art

In the present world, the shortage of water resources becomes increasingly serious. An emerging problem for companies and individuals using plenty of water every day to face and solve is how to save water sources and production and operation costs. The laundry water in laundry plants is usually treated as sewage and directly discharged into sewage treatment plants. If the sewage can be treated and recycled by water-using companies, not only a lot of production cost can be saved, the waste of water resources can be reduced, but also the burden of sewage treatment can be lightened.

### SUMMARY OF THE INVENTION

In view of the above-described problems, it is one objective of the invention to provide a method and a device for treating the high/low-turbidity laundry or car-washing wastewater into clear tap water (the water quality can reach the standards of purified water) for recycling use.

To achieve the above objective, in accordance with one embodiment of the invention, there is provided a method for treating car-washing and laundry wastewater, comprising the steps of:
(1) flocculating and granulating the wastewater in a wastewater collection pool through a flocculation sedimentation tank, the temperature of the wastewater ranging from 0° C. to 90° C.;
(2) pumping the flocculated water with a high/low turbidity into a hair filter through a lift pump, to remove hair and fiber;
(3) pumping the pretreated water into an organic/inorganic membrane filter under the combined action of a delivery pump and a booster pump after the water pressure rises to 2-5 Kg, so as to remove the sediment, oil dirt, human skin bits, and bacteria to yield clear water, the turbidity of the clear water being reduced to less than 1 degree (NTU), the water comprising a detergent and thus being alkaline;
(4) treating the clear water containing the detergent with activated carbon in an activated carbon filter and an ultraviolet lamp in an ultraviolet sterilization device to remove organic matters and bacteria, storing the treated clear water in a sanitary-grade purified water storage tank, and regulating the pH value of the water to be neutral with a pH value regulating device; the neutral clear water being delivered to a clothes-washing or car-washing site for initial cleaning of clothes or cars;
(5) raising the water pressure to 10-15 Kg by a high-pressure pump, and pumping the neutral clear water into a reverse osmosis apparatus for further removal of inorganic matters, organic matters, virus, and bacteria to obtain purified water which is used for rinsing of washed clothes as well as for final washing of washed cars.

In a class of this embodiment, the pH value regulating device comprises an injection pump and a water tank. The water tank is filled with a pH value regulator. The pH value regulator is injected via the injection pump. The water quality of the detergent-containing clear water stored in the purified water storage tank is regulated to be neutral, and the neutral clear water is delivered to a clothe-washing or car-washing site via the delivery pump for initial cleaning of clothes or cars.

In accordance with another embodiment of the invention, there is provided a device for recycling treatment of car-washing and laundry wastewater, comprising: a flocculation sedimentation tank, a prefilter, a flocculation injection pump, a lift pump, a delivery pump, a hair filter, a booster pump, an organic/inorganic membrane filter, an activated carbon filter, a flowmeter, an ultraviolet (UV) sterilization device, and a reverse osmosis apparatus.

The lift pump is installed on the side of the flocculation sedimentation tank, and the prefilter is installed at an inlet of the lift pump and sinks into the flocculation sedimentation tank; the inlet of the lift pump is connected with the hair filter through a pipe, and the laundry or car-washing wastewater is pumped into the hair filter through the lift pump; a hair filtering device is installed in the hair filter; the hair filtering device comprises a filter filtering screen and a water cap.

An inlet of the delivery pump is connected with the hair filter, an outlet of the delivery pump is butted with an inlet of the booster pump, and an outlet of the booster pump is communicated with the organic/inorganic membrane filter through a pipe; after the water pressure rises to 4-5 kg, the water is pumped into the organic/inorganic membrane filter for filtering treatment under the combined action of the delivery pump and the booster pump; two booster pumps are adopted, and connected in parallel to work alternately by 12 hours, so as to prevent the coil from being burned due to the overheated motor. The characteristic of the system also lies in the series connection between the delivery pump and the booster pump, wherein one of the two pumps is a small-flow and high-lift pump, the other pump is a high-flow and small-lift pump, the two pumps are connected in series to obtain a total flow and a total lift, and the power consumption is less relative to that in a single booster pump; one pump can also be independently used in the system as the delivery pump for the wastewater with turbidity.

A water outlet of the organic/inorganic membrane filter is communicated with a water inlet of the activated carbon filter through a pipe after passing through the clear water flowmeter, a water outlet of the activated carbon filter is communicated with a water inlet of the ultraviolet (UV) sterilization device through a pipe, a water outlet of the ultraviolet (UV) sterilization device is connected with the purified water storage tank through a pipe, and a pH value regulating device is installed in the purified water storage tank, so that the water quality is regulated to be neutral; an organic filtering membrane is installed in the organic membrane filter and selects a commercial organic filtering membrane; an inorganic filtering membrane is installed in the inorganic membrane filter and selects a commercial inorganic filtering membrane.

A water inlet of the high-pressure pump is connected with the purified water storage tank, and a water outlet of the high-pressure pump is communicated with the reverse osmosis apparatus and the clothes-washing or car-washing site through pipes.

In a class of this embodiment, a set of backwashing systems is configured for the organic/inorganic membrane filter, and comprises a backwashing pump and a backwashing water storage tank; the backwashing time and the interval time are controlled via a PLC (Programmable Logic Controller) system; the set of the backwashing systems is used for washing the surface of the filtering membrane, thereby prolonging the service life and improving the working efficiency.

In a class of this embodiment, a ROM (reverse osmosis membrane) is arranged in the reverse osmosis apparatus, which is a semipermeable membrane and synthesized with artificial chemicals. The average gap of the reverse osmosis membrane is about 0.0001μ (1 Å), which is exactly similar to the diameter of water molecule. Thus, the water molecule can reach the other side after permeating the membrane under the action of pressure, most metals and compounds cannot permeate the membrane due to the diameter larger than that the membrane space, and it's harder for the virus with a diameter of 0.02-0.4μ and bacteria with a diameter of 0.4-1μ to permeate the membrane.

There are many visible substances in the laundry and car-washing wastewater, such as sediment, human skin bits, hair, fiber and other foreign impurities, thus the prefilter (manufactured according to the physical principles) is adopted for pretreatment, and part of foreign impurities in the high-turbidity or low-turbidity water can be filtered out, so as to reduce the burden of the subsequent filtering. The flocculation injection system is adopted and used for flocculating and granulating the foreign impurities in the water, so as to filter the foreign impurities out through the organic/inorganic membrane filter, then the hair, fiber and other foreign impurities left in the water is further filtered through the hair filter, the burden of filtering the foreign impurities with the organic/inorganic membrane filter is further reduced. The wastewater treated through the organic/inorganic membrane filter comprises clear water and concentrated water. The clear water enters the activated carbon filter after the flow is accurately detected in real time through a flowmeter, and the odor and some organic matters in the purified water can be effectively removed; since the treated clear water contains part of bacteria, the ultraviolet (UV) sterilization device is arranged behind the activated carbon filter; the content of bacteria in the clear water can be effectively reduced, so as to prepare for the next purification by a reverse osmosis method. The water is stored in the sanitary-grade purified water storage tank after sterilization through the ultraviolet sterilization device, and then is input into the reverse osmosis apparatus under the pressure of the high-pressure pump, so that the laundry wastewater is treated into clear water, but detergent is still retained in the clear water, the water is alkaline. The pH value regulating device is adopted in the system, and after the water quality is regulated to be neutral, the water is delivered to a clothes-washing or car-washing site for initial cleaning of clothes or cars via the high-pressure pump; a set of backwashing systems is configured for the organic membrane (inorganic membrane) filter, because after a period of time of work of the membrane, the surface of the membrane is covered by the sticky substances in water and further scaled, the pore in the membrane is blocked, the water yield is further reduced, and the working efficiency is low; the set of the backwashing systems comprises a backwashing pump and a backwashing water storage tank, the backwashing time and the interval time are controlled via a PLC (Programmable logic Controller) system, and the set of the backwashing systems is used for washing the surface of the membrane, so that the service life is prolonged, and the working efficiency is improved.

To avoid the membrane from blockage and damage, the filtering systems mentioned above can be used for effectively removing the mud, sand, iron chips, fiber and organic compounds in the water; after getting through the reverse osmosis apparatus, the detergent in the clear water is effectively removed to obtain purified water, and then the purified water is delivered to a final clothes-washing or car-washing site via the delivery pump for final rinsing of clothes as well as final washing of cars.

Advantages of the invention are summarized below: 1. the recovery ratio of waste water is high and can reach 85%-95%, thus the purpose of recycling the circulating water equipment is really achieved; 2. the treated circulating water is clear and transparent, odorless and tasteless, and the water injected at one time can be recycled for a long term; 3. the operating maintenance cost is low, the double-pump series connection method is adopted, thus the energy consumption is low; and 4. the occupied area of the equipment is small, the civil work is not required, and the equipment is available at any moment.

### BRIEF DESCRIPTION OF THE DRAWINGS

The invention is described hereinbelow with reference to accompanying drawings, in which the sole FIGURE is a flowchart of the laundry wastewater recycling system.

In the drawings, the following reference numbers are used: flocculation sedimentation tank 1, prefilter 2, lift pump 3, hair filter 4, delivery pump 5, booster pump 6, pressure gauge 7, organ/inorganic membrane filter 8, flowmeter 9, activated carbon filter 10, ultraviolet (UV) sterilization device 11, concentrated water flowmeter 12, pH value regulating device 13, purified water storage tank 14, float level switch 15, high-pressure pump 16, reverse osmosis apparatus 17, backwashing pump 18, backwashing water storage tank 19, clothes-washing or car-washing site 20.

### DETAILED DESCRIPTION OF THE EMBODIMENTS

As shown in the sole FIGURE, a device for recycling treatment of car-washing and laundry wastewater comprises a flocculation sedimentation tank 1, a prefilter 2, a flocculation injection pump, a lift pump 3, a delivery pump 5, a hair filter 4, a booster pump 6, an organic membrane filter or inorganic membrane filter 8, an activated carbon filter 10, a flowmeter 9, an ultraviolet (UV) sterilization device 11, and a reverse osmosis apparatus 17.

The lift pump 3 is installed on the side of the flocculation sedimentation tank 1, and the prefilter 2 is installed at an inlet of the lift pump 3 and sinks into the flocculation sedimentation tank 1; the inlet of the lift pump 3 is connected with the hair filter 4 through a pipe, and the laundry or car-washing wastewater is pumped into the hair filter 4 through the lift pump 3; a hair filtering device is installed in the hair filter 4; the hair filtering device comprises a hair filtering screen and a water cap; the prefilter 2 adopts a stainless steel filtering screen.

An inlet of the delivery pump 5 is connected with the hair filter 4, an outlet of the delivery pump 5 is butted with an inlet of the booster pump 6, and an outlet of the booster pump 6 is communicated with the organic membrane filter or inorganic membrane filter 8 through a pipe; after the water pressure rises to 2-5 kg, the water is pumped into the organic/inorganic membrane filter 8 for filtering treatment under the combined action of the delivery pump 5 and the booster pump 6; two booster pumps are adopted, and connected in parallel to be used alternately by 12 hours, so as to prevent the coil from being burned due to the overheated motor. The characteristic of the system also lies in the series connection between the delivery pump and the booster pump, wherein one of the two pumps is a small-flow and high-lift pump, the other pump is a high-flow and small-lift pump, the two pumps are connected in series to obtain a total flow and a total lift, and the power consumption is less relative to that in the used single booster pump; one pump can also be independently used in the system as the delivery pump for the wastewater with turbidity.

A water outlet of the organic/inorganic membrane filter 8 is communicated with a water inlet of the activated carbon filter 10 through a pipe after passing through the flowmeter 9, a water outlet of the activated carbon filter 10 is communicated with a water inlet of the ultraviolet (UV) sterilization device 11 through a pipe, a water outlet of the ultraviolet (UV) sterilization device 11 is communicated with the purified water storage tank 14 through a pipe, a pH value regulating device 13 is installed in the purified water storage tank 14 and comprises an injection pump and a water tank, wherein the water tank is filled with pH value regulator, the pH value regulator is injected through the injection pump, and the water quality is regulated to be neutral; a commercial organic filtering membrane is installed in the organic membrane filter; a commercial inorganic filtering membrane is installed in the inorganic membrane filter; the pH value regulator adopts a commercial water treatment pH value regulator.

A water inlet of the high-pressure pump 16 is connected with the purified water storage tank 14, and a water outlet of the high-pressure pump 16 is communicated with the reverse osmosis apparatus 17 and a clothes-washing or car-washing site 8 through pipes; a float level switch 15 is installed in the purified water storage tank 14.

A set of backwashing systems 17 is configured for the organic/inorganic membrane filter 8, and comprises a backwashing pump 18 and a backwashing water storage tank 19; the backwashing time and the interval time are controlled via a PLC (Programmable Logic Controller) system; the set of the backwashing systems is used for washing the surface of the filtering membrane, thereby prolonging the service life and improving the working efficiency.

A ROM (reverse osmosis membrane) is arranged in the reverse osmosis apparatus 17, which is a semipermeable membrane and synthesized with artificial chemicals. The average gap of the reverse osmosis membrane is about 0.0001μ (1 Å), which is exactly similar to the diameter of water molecule. Thus, the water molecule can reach the other side after permeating the membrane under the action of pressure, while most metals and compounds cannot permeate the membrane due to the diameter larger than that the membrane gap, and it's harder for the virus with diameter of 0.02-0.4μ and bacteria with diameter of 0.4-1μ to permeate the membrane.

A method for treating car-washing and laundry wastewater, comprising the steps of:
(1) flocculating and granulating the wastewater in a wastewater collection pool through a flocculation sedimentation tank, the temperature of the wastewater ranging from 0° C. to 90° C.;
(2) pumping the flocculated water with a high/low turbidity into a hair filter 4 through a lift pump 3, to remove hair and fiber;
(3) pumping the pretreated water into an organic/inorganic membrane filter 8 under the combined action of a delivery pump 5 and a booster pump 6 after the water pressure rises to 2-5 Kg, so as to remove the sediment, oil dirt, human skin bits, and bacteria to yield clear water, the turbidity of the clear water being reduced to less than 1 degree (NTU), the water being alkaline due to detergent still retained;
(4) treating the clear water containing detergent with activated carbon in an activated carbon filter and an ultraviolet lamp in an ultraviolet sterilization device 11 to remove organic matters and bacteria, storing the treated clear water in a sanitary-grade purified water storage tank 14, and regulating the pH value of the water to be neutral with a pH value regulating device 13; the neutral clear water being delivered to a clothes-washing or car-washing site for initial cleaning of clothes or cars;
(5) raising the water pressure to 10-15 Kg by a high-pressure pump 16, and pumping the neutral clear water into a reverse osmosis apparatus 17 for further removal of inorganic matters, organic matters, virus, and bacteria to obtain purified water which is used for rinsing of washed clothes as well as for final washing of washed cars.

The pH value regulating device 13 comprises an injection pump and a water tank. The water tank is filled with a pH value regulator. The pH value regulator is injected via the injection pump. The water quality of the detergent-containing clear water stored in the purified water storage tank is regulated to be neutral, and the neutral clear water is delivered to a clothe-washing or car-washing site via the delivery pump for initial cleaning of clothes or cars.

As shown in the sole FIGURE, the method for recycling the car-washing and laundry wastewater is realized as follows:

1. The laundry or car-washing wastewater required to be treated is collected in the large flocculation sedimentation tank 1, the lift pump 3 is installed on the side of the flocculation sedimentation tank 1, the prefilter 2 is installed at an inlet of the lift pump 3 and sinks into the flocculation sedimentation tank 1; the laundry or car-washing wastewater is pumped into the hair filter 4 through the lift pump 3.

2. An inlet of the delivery pump 5 is connected with the hair filter 4, an outlet of the delivery pump 5 is butted with an inlet of the booster pump 6, and after the water pressure rises to 2-5 kg, the water is pumped into the organic/inorganic membrane filter 8 for filtering treatment under the combined action of the delivery pump 5 and the booster pump 6; two booster pumps are adopted, and connected in parallel to be used alternately by 12 hours, so as to prevent the coil from being burned due to the overheated motor; besides, the characteristic of the system also lies in the series connection between the delivery pump 5 and the booster pump 6, wherein one of the two pumps is a small-flow and high-lift pump, the other pump is a high-flow and small-lift pump, the two pumps are connected in series to obtain a total flow and a total lift, and the power consumption is less relative to that in the used single booster pump; one pump can also be independently used in the system as the delivery pump for the wastewater with turbidity; a pressure gauge 7 is installed on an outlet pipeline of the booster pump 6.

3. The wastewater treated through the organic/inorganic membrane filter 8 comprises clear water and concentrated water, and the clear water is input to the activated carbon filter 10 after the flow is accurately detected in real time through a flowmeter 9, so as to effectively remove some organic matters and odor in the water; the water is continued to flow into the ultraviolet (UV) sterilization device 11, the ultraviolet (UV) sterilization device 11 is equipped with an ultraviolet lamp, and the bacteria in the water can be effectively killed through the ultraviolet rays generated by the ultraviolet (UV) sterilization device 11, so as to reduce the bacteria index in the water and prepare for the next purification by reverse osmosis; the water is stored in the sanitary-grade purified water storage tank 14 after sterilization through the ultraviolet (UV) sterilization device 11, and then is input into the reverse osmosis apparatus 17 under the pressure of the high-pressure pump 16, so that the laundry wastewater is treated into clear water, but detergent is still retained in the clear water, and the water is alkaline; the pH value regulating device 13 is adopted in the system here and comprises an injection pump and a water tank, wherein the water tank is filled with pH value regulator, the pH value regulator is injected into the purified water storage tank 14 through the injection pump, and after the water quality is regulated to be neutral, the water is delivered to a clothes-washing or car-washing site 20 for initial cleaning of clothes or cars via the high-pressure pump 16; a float level switch 15 is installed in the purified water storage tank 14 for controlling the liquid level in the purified water storage tank 14; a set of backwashing systems is configured for the organic membrane (inorganic membrane) filter 8, because after a period of time of work of the membrane, the surface of the membrane is covered by the sticky substances in water and further scaled, the pore in the membrane is blocked, the water yield is further reduced, and the working efficiency is low; the set of the backwashing systems comprises a backwashing pump 18 and a backwashing water storage tank 19, the backwashing time and the interval time are controlled via a PLC (Programmable logic Controller) system, and the set of the backwashing systems is used for washing the surface of the membrane, so that the service life is prolonged, and the working efficiency is improved; part of concentrated water can return to an inlet pipe of the delivery pump 5 through a control valve and a concentrated water flowmeter 12 for further treatment with the pretreated water.

4. A ROM (reverse osmosis membrane) is arranged in the reverse osmosis apparatus 17, which is a semipermeable membrane and synthesized with artificial chemicals. The average gap of the reverse osmosis membrane is about 0.0001μ (1 Å), which is exactly similar to the diameter of water molecule. Thus, the water molecule can reach the other side after permeating the membrane under the action of pressure, most metals and compounds cannot permeate the membrane due to the diameter larger than that the membrane space, and it's harder for the virus with diameter of 0.02-0.4μ and bacteria with diameter of 0.4-1μ to permeate the membrane. To avoid the membrane from blockage and damage, the filtering systems mentioned above can be used for effectively removing the mud, sand, iron chips, fiber and organic compounds in the water; after getting through the reverse osmosis apparatus 17, various inorganic matters, organic matters, virus and bacteria in the water are further removed to obtain the purified water, and then the purified water is delivered to a final cleaning site via the delivery pump for final rinsing or washing of clothes or cars.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for treating car-washing and laundry wastewater, comprising the steps of:
a) flocculating and granulating the wastewater in a wastewater collection pool through a flocculation sedimentation tank, the temperature of the wastewater ranging from 0° C. to 90° C.;
b) pumping the flocculated water with a high/low turbidity into a hair filter through a lift pump, to remove hairs and fibers;
c) pumping the pretreated water into an organic/inorganic membrane filter under the combined action of a delivery pump and a booster pump after the water pressure rises to between 2 and 5 Kg, whereby removing sediment, oil dirt, human skin bits, and bacteria to yield clear water, the turbidity of the clear water being reduced to less than 1 degree (NTU), the clear water comprising a detergent and thus being alkaline;
d) treating the clear water comprising the detergent with activated carbon in an activated carbon filter and an ultraviolet lamp in an ultraviolet sterilization device to remove organic matters and bacteria, storing the treated clear water in a sanitary-grade purified water storage tank, and regulating the pH value of the water to be neutral with a pH value regulating device; and
e) raising the water pressure to between 10 and 15 Kg by a high-pressure pump, and pumping the neutral clear water into a reverse osmosis apparatus for further removal of inorganic matters, organic matters, virus, and bacteria to obtain purified water which is used for rinsing of washed clothes as well as for final washing of washed car.

2. The method of claim 1, wherein
the pH value regulating device comprises an injection pump and a water tank;
the water tank is filled with a pH value regulator;
the pH value regulator is injected via the injection pump;
the water quality of the detergent-containing clear water stored in the purified water storage tank is regulated to be neutral; and
the neutral clear water is delivered to a clothe-washing or car-washing site via the delivery pump for initial cleaning of clothes or cars.

3. A device for recycling treatment of car-washing and laundry wastewater, comprising:
a) a flocculation sedimentation tank;
b) a prefilter;
c) a flocculation injection pump;
d) a lift pump;
e) a delivery pump;
f) a hair filter;
g) a booster pump;
h) an organic/inorganic membrane filter;
i) an activated carbon filter;
j) a flowmeter;
k) an ultraviolet sterilization device; and
l) a reverse osmosis apparatus;
wherein
the lift pump is installed on the side of the flocculation sedimentation tank, and the prefilter is installed at an inlet of the lift pump and sinks into the flocculation sedimentation tank; the inlet of the lift pump is connected with the hair filter through a pipe, and the laundry or car-washing wastewater is pumped into the hair filter through the lift pump; a hair filtering device is installed in the hair filter;
an inlet of the delivery pump is connected with the hair filter, an outlet of the delivery pump is butted with an inlet of the booster pump, and an outlet of the booster pump is communicated with the organic/inorganic membrane filter through a pipe; after the water pressure rises to between 4 and 5 kg under the combined action of the delivery pump and the booster pump, the water is pumped into the organic/inorganic membrane filter for filtering treatment;
a water outlet of the organic/inorganic membrane filter is communicated with a water inlet of the activated carbon filter through a pipe after passing through the clear water flowmeter, a water outlet of the activated carbon filter is communicated with a water inlet of the ultraviolet sterilization device through a pipe, a water outlet of the ultraviolet sterilization device is connected with the purified water storage tank through a pipe, and a pH value regulating device is installed in the purified water storage tank; the pH value regulating device comprises an injection pump and a water tank; the water tank is filled with a pH value regulator; the pH value regulator is injected via the injection pump, so that the water quality is regulated to be neutral; and
a water inlet of the high-pressure pump is connected with the purified water storage tank, and a water outlet of the high-pressure pump is communicated with the reverse osmosis apparatus and the clothes-washing or car-washing site through pipes.

4. The device of claim 3, wherein a set of backwashing systems is configured for the organic/inorganic membrane filter, and comprises a backwashing pump and a backwashing water storage tank; the backwashing time and the interval time are controlled via a programmable logic controller system; the set of the backwashing systems is used for washing the surface of the filtering membrane.

5. The device of claim 3, wherein a reverse osmosis membrane is arranged in the reverse osmosis apparatus, and the average gap of the reverse osmosis membrane is about 0.0001μ.

6. The device of claim 3, wherein the hair filtering device comprises a filter filtering screen and a water cap.

7. The device of claim 3, wherein two booster pumps are employed and connected in parallel, and the delivery pump and the booster pump are connected in series.

8. The device of claim 3, wherein an organic filtering membrane is installed in the organic membrane filter and an inorganic filtering membrane is installed in the inorganic membrane filter.

9. The device of claim 3, wherein the prefilter employs a stainless steel filtering screen.
